(19) United States
(12) Patent Application Publication
(10) Pub. No.: US 2023/0163400 A1
(43) Pub. Date: May 25, 2023

(54) VEHICLE BATTERY PACK TRAY WITH MULTIPLE ACCESS POINTS

(71) Applicant: Polestar Performance AB, Göteborg (SE)

(72) Inventors: Nicky Hoggarth, Gothenburg (SE); Martin Andersson, Gothenburg (SE); Johan Janers, Gothenburg (SE); Kris Morris, Gothenburg (SE); Ben Railton, Gothenburg (SE)

(21) Appl. No.: 17/531,375

(22) Filed: Nov. 19, 2021

(51) Int. Cl. H01M 50/271; H01M 50/249; H01M 50/209; B60K 1/04

(52) U.S. Cl. CPC H01M 50/271; B60K 1/04; H01M 50/209; H01M 50/249; B60K 2001/0438; H01M 2220/20

(57) ABSTRACT

A vehicle battery pack for electric vehicle, including a battery tray defining a battery compartment configured to house at least one of plurality of battery modules or individual battery cells, a current transmission system, a temperature regulation system, a safety system, a battery management system, and a current management system, a cover configured to operably coupled to the battery tray, thereby sealing the battery compartment, the cover defining two or more access doors, and two or more service lids operably coupleable to the cover, thereby selectively providing access to the battery compartment through the two or more access doors.

### TECHNICAL FIELD

The present disclosure relates generally to battery systems for electric vehicles, and more particularly to a vehicle battery pack with multiple doors or hatches enabling access to an interior of an otherwise sealed electric vehicle battery.

### BACKGROUND

Electrical vehicles are becoming increasingly popular as consumers look to decrease their environmental impact and improve air quality. Instead of a traditional internal combustion engine, electric vehicles include one or more electric motors, powered by a rechargeable battery pack. Conventional electric vehicle battery packs are typically constructed of multiple components, including a plurality of battery modules, electrical current transmission systems, temperature control systems, safety systems, battery management systems, and one or more structural supports.

Conventional construction techniques begin with an empty battery tray, which represents a bottom and typically one or more sides of a structural vessel, representing a compartment, configured to contain the other components of the battery pack. Often the battery tray includes one or more structural supports (e.g., cross members, etc.), providing structural support to the battery pack, as well as surfaces within the battery tray compartment on which other components of the battery pack can be affixed. The various components, including the temperature control system (e.g., cooling panels, etc.) and plurality of battery modules can be positioned within the compartment and secured in place. Electrical current transmission systems, battery management systems, and safety systems are also positioned within the compartment. A lid or cover is then positioned on the battery tray, thereby sealing the compartment.

Sealing the battery compartment serves to isolate the components positioned within the battery tray from the outside environment, which in turn inhibits the intrusion of moisture and corrosion inducing chemicals (e.g., oxygen, road salt, etc.), and inhibits fluid within the compartment from leaking out, for example in the event of a battery module failure. Although sealing of the battery compartment has proved useful for its intended purpose, there is occasionally a need to access components within the sealed compartment. Current techniques of gaining access to the sealed compartment typically include removal of the lid or cover, which is typically affixed to the tray with a combination of fasteners and adhesive. As the lid or cover typically encompasses the entire top surface of the battery pack, after installation in a vehicle, the battery pack must be removed from a vehicle (e.g., uncoupled from a vehicle frame) before the lid or cover can be removed. Accordingly, gaining access to the sealed compartment of a battery pack can be a labor-intensive endeavor. The present disclosure addresses this concern.

### SUMMARY OF THE DISCLOSURE

Embodiments of the present disclosure provide vehicle battery packs and methods of construction comprising multiple access or service lids, enabling selective access to an otherwise sealed compartment containing various components of the battery pack, thereby enabling components within the battery pack (e.g., battery modules, battery management systems, etc.) to be serviced without a need to remove the entire battery pack from a vehicle. In some embodiments, the multiple access or service lids can be sealed with a flange and adhesive gasket arrangement to ensure proper sealing of the battery pack, while enabling repeated access to the sealed compartment through the multiple axis or service lids.

One embodiment of the present disclosure provides a vehicle battery pack for electric vehicle, including a battery tray defining a battery compartment configured to house at least one of plurality of battery modules or individual battery cells, a current transmission system, a temperature regulation system, a safety system, a battery management system, and a current management system, a cover configured to operably coupled to the battery tray, thereby sealing the battery compartment, the cover defining two or more access doors, and two or more service lids operably coupleable to the cover, thereby selectively providing access to the battery compartment through the two or more access doors.

In one embodiment, the two or more access doors are positioned on an aft portion of the cover. In one embodiment, the cover defines a foot well for a backseat of the electric vehicle. In one embodiment, the two or more access doors are positioned aft of the foot well. In one embodiment, the two or more service lids are accessible by removal of the backseat. In one embodiment, the two or more service lids are secured to the cover via a plurality of fasteners. In one embodiment, the vehicle battery pack further includes an adhesive gasket positioned between each service lid and the cover, the adhesive gasket providing a seal between each service lid and the cover.

Another embodiment of the present disclosure provides a selectively sealable vehicle battery pack for electric vehicle configured to enable selective access to components within the battery pack, without a need to remove the battery pack from a vehicle in which it is installed, including a vessel defining a compartment configured to house at least one of plurality of battery modules or individual battery cells, a current transmission system, a temperature regulation system, a safety system, a battery management system, and a current management system, a cover configured to operably coupled to the vessel, thereby sealing the compartment, the cover defining two or more access doors, and two or more service lids operably coupleable to the cover, thereby selectively providing access to the battery compartment through the two or more access doors.

In one embodiment, the two or more access doors are positioned on a portion of the cover positioned beneath a back seat of the electric vehicle. In one embodiment, the cover defines a foot well for a backseat of the electric vehicle. In one embodiment, each of the service lids are substantially rectangular in shape. In one embodiment, each of the service lids define a U-shaped channel arranged around a perimeter of the service lid. In one embodiment, the U-shaped channel defines a plurality of apertures are configured to receive a corresponding plurality of fasteners. In one embodiment, the two or more service lids are secured to the cover via a plurality of fasteners. In one embodiment, each of the service lids is constructed through a process of stamping sheet metal. In one embodiment, the battery pack further includes an adhesive gasket positioned between each service lid and the cover, the adhesive gasket providing a seal between each service lid and the cover. In one embodiment, a central portion of each service lid is shaped to accommodate one or more components of the battery pack partially protruding through the two or more access doors. In one embodiment, at least one of a battery management system or a current management system positioned within the compartment is accessible by removal of the two or more access doors. In one embodiment, removal of the two or more access doors enables a user to at least one of perform diagnostics, change a fuse, reset a replay, or perform software updates to the battery pack.

Another embodiment of the present disclosure provides a vehicle battery pack for electric vehicle, the vehicle battery pack, including a battery tray defining a battery compartment configured to house at least one of plurality of battery modules or individual battery cells, a current transmission system, a temperature regulation system, a safety system, a battery management system, and a current management system, a cover configured to operably coupled to the battery tray, thereby sealing the battery compartment, the cover defining a foot well for a backseat to the electric vehicle and two or more access doors, wherein the two or more access doors are positioned aft of the foot well, two or more substantially rectangular service lids operably coupleable to the cover, thereby selectively providing access to the battery compartment through the two or more access doors, wherein each of the service lids define a U-shaped channel arranged around a perimeter of the service lid, the channel defining a plurality of apertures configured to receive a corresponding plurality of fasteners, wherein the two or more service lids are secured to the cover via the plurality of fasteners, an adhesive gasket positioned between each service lid and the cover, the adhesive gasket providing a seal between each service lid and the cover, wherein the two or more service lids are accessible by removal of the backseat of the vehicle.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a vehicle battery pack comprising multiple access lids for positioning in an electric vehicle, in accordance with an embodiment of the disclosure.

FIG. 2 is a perspective view of a vehicle battery pack tray loaded with a plurality of battery pack components, in accordance with an embodiment of the disclosure.

FIG. 3A is a perspective view of a battery pack including a lid defining multiple access points to access battery components within the battery compartment, in accordance with an embodiment of the disclosure.

FIG. 3B is a perspective view of the battery pack of FIG. 3A, wherein the multiple access points are sealed by respective lids, in accordance with an embodiment of the disclosure.

FIG. 4A is a perspective view of a vehicle including a battery pack having multiple access doors sealed by respective lids, in accordance with an embodiment of the disclosure.

FIG. 4B is a perspective view of the vehicle of FIG. 5A, in which additional panels are installed over the respective lids, in accordance with an embodiment of the disclosure.

FIG. 5 is a close-up, perspective view depicting a battery pack access door, in accordance with an embodiment of the disclosure.

FIG. 6A is a top perspective view of a battery pack access lid, in accordance with an embodiment of the disclosure.

FIG. 6B is a bottom perspective view of the battery pack access lid of FIG. 4A.

FIG. 7A is a plan view of a battery pack access lid, in accordance with an embodiment of the disclosure.

FIG. 7B is a lateral cross-sectional view of the battery pack access lid of FIG. 5A.

FIG. 7C is a longitudinal cross-sectional view of the battery pack access lid of FIG. 5A.

FIG. 8 is a partial, cross-sectional, perspective view depicting an interaction between a service led and a cover of the battery pack, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

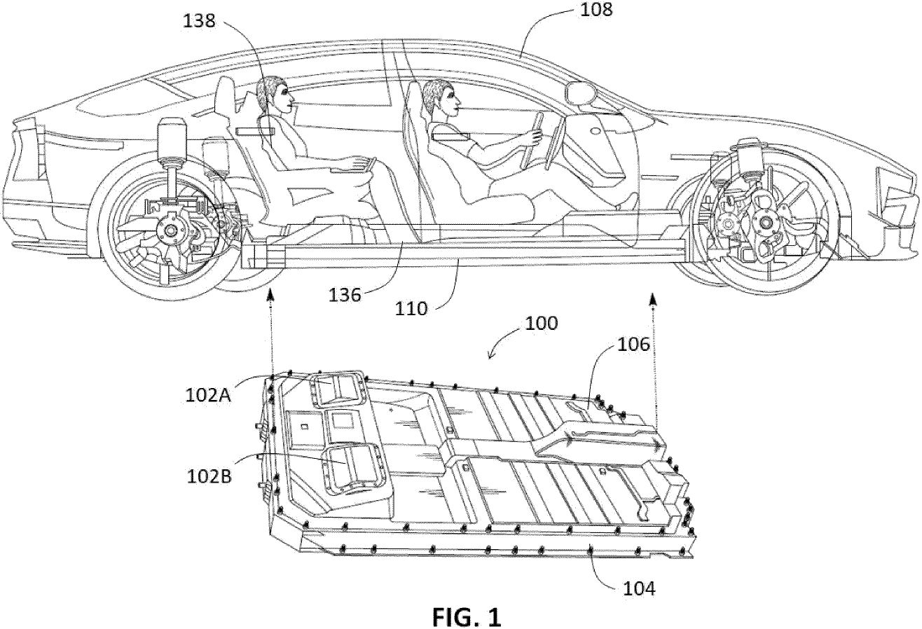

Referring to FIG. 1, a vehicle battery pack 100 comprising multiple access or service lids 102A/B enabling selective access to an otherwise sealed compartment containing various components of the battery pack, is depicted in accordance with an embodiment of the disclosure. As depicted in FIG. 1, in some embodiments, the battery pack 100 can include a battery tray 104, defining a compartment into which components of the battery pack can be positioned. A cover 106 can be affixed to the battery tray 104, thereby sealing the battery compartment. Thereafter, the assembled battery pack 100 can be mounted to the frame and/or chassis of a vehicle 108, which in some embodiments can be positioned adjacent to a cabin floor 110 of the vehicle 108, thereby maintaining a low center of gravity.

Various embodiments of the present invention will be described in detail with reference to the drawings, wherein like reference numerals represent like parts and assemblies throughout the several views. Various directions and orientations, such as “upward,” “downward,” “top,” “bottom,” “upper,” “lower”, etc. are generally described herein with reference to the drawings in the usual gravitational frame of reference, regardless of how the components may be oriented during assembly.

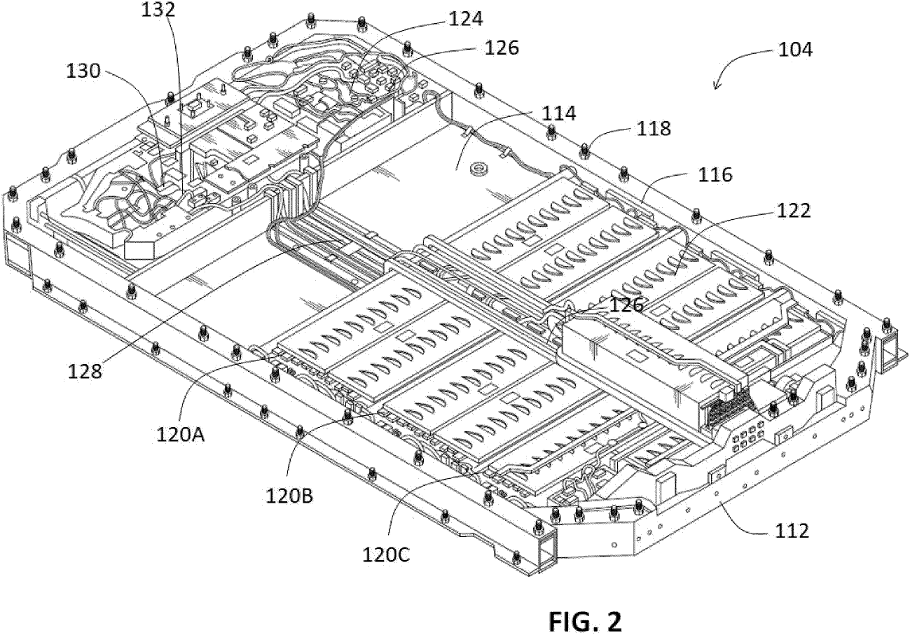

With additional reference to FIG. 2, a battery tray 104, which can represent a bottom and one or more sides of a structural vessel 112 defining a compartment 114, is depicted in accordance with an embodiment of the disclosure. In some embodiments, the battery tray 104 can include one or more structural supports, such as cross member 120A-C, which can provide structural support to the battery pack 100, as well as surfaces within the compartment 114 on which other components of the battery pack can be affixed.

A variety of components can be packed into the compartment 114 before the cover 106 (as depicted in FIG. 1) is affixed to a top surface 116 of the battery tray 104, thereby sealing the compartment 114 their within. In some embodiments, the components can include a plurality of battery modules 122, electrical current transmission systems 124, temperature control systems 126, safety systems 128, battery management systems 130 (including current management systems 132), and the like. Once the components have been positioned in the compartment 114, the cover 106 can be affixed to the top surface 116 via a plurality of fasteners 118, adhesive, or a combination thereof.

Although sealing of the battery compartment 114 is effective in inhibiting the introduction of corrosion inducing chemicals and moisture, as well as inhibiting the leakage of fluids in the event of a battery module failure, occasionally technicians may require access to the battery compartment 114, for example to address a faulty battery module 122, reset battery management systems 130, change a fuse or relay on a current management system 132, or the like. In an effort to reduce the labor intensive endeavor of removing the entire battery pack 100 from the vehicle 110 in order to remove the cover 106, embodiments of the present disclosure provide multiple service lids 102A/B enabling selective access to the sealed compartment 114.

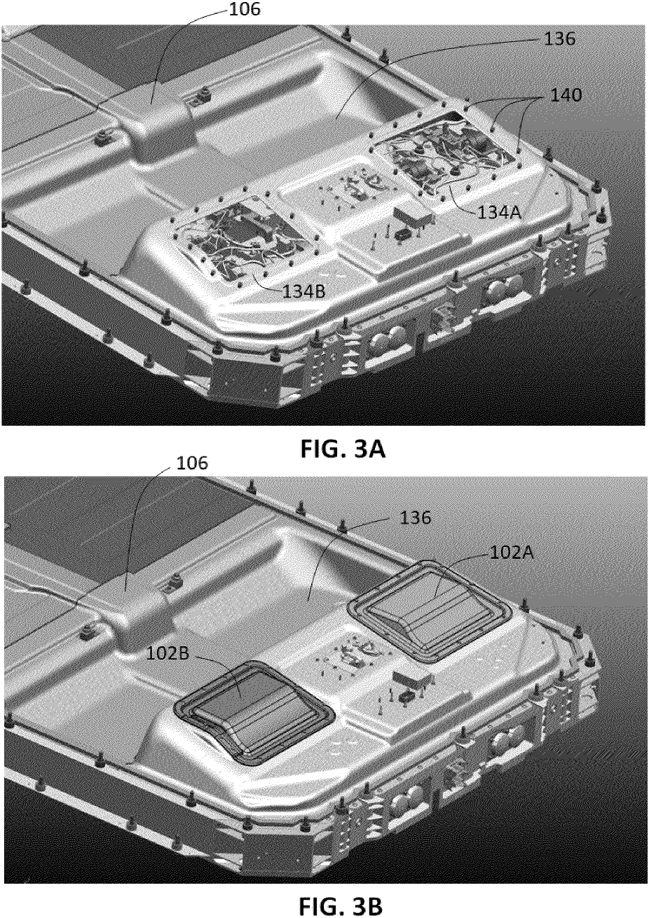

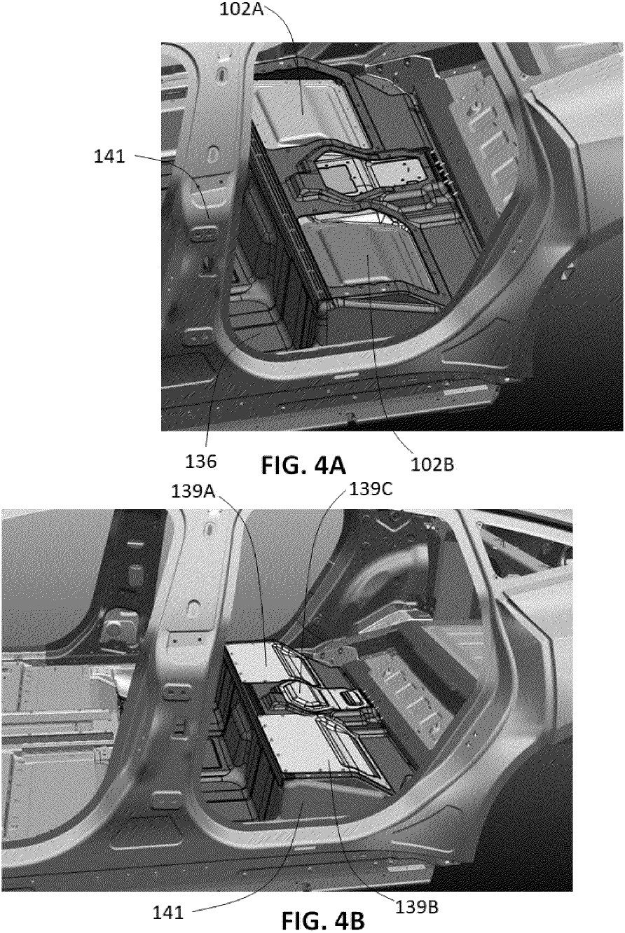

For example, as depicted in FIGS. 3A-4B, a vehicle battery pack 100 comprising a cover 106 defining one or more access doors 134A/B selectively sealed by service lids 102A/B, is depicted in accordance with an embodiment of the disclosure. In some embodiments, the one or more access doors 134A/B can be positioned on an aft portion of the cover 106. For example in one embodiment, the cover 106 can define a rear foot well 136 for passengers positioned in a rear or backseat 138 of the vehicle 108 (as depicted in FIG. 1). The one or more access doors 134A/B and service lids 102A/B can be positioned aft the rear foot well 136, so as to be positioned beneath the rear seat 138. In some embodiments, one or more panels 139A-C can be operably coupled to a frame 141 of the vehicle 108, thereby providing an access point to the service lids 102A/B.

A variety of components can be positioned within the battery compartment 114 for access through the one or more access doors 134A/B. For example, as depicted, in one embodiment at least one of the battery management system 130 or current management system 132 can be accessible through the one or more access doors 134A/B, thereby enabling a user to remove and replace components, change fuses, perform diagnostics or software updates, etc. Further, in some embodiments, the one or more access doors 134A/B can be positioned to enable user to access one or more battery modules 122, current transmission systems 124, temperature regulation systems 126, and safety systems 128 among other components of the battery pack 100.

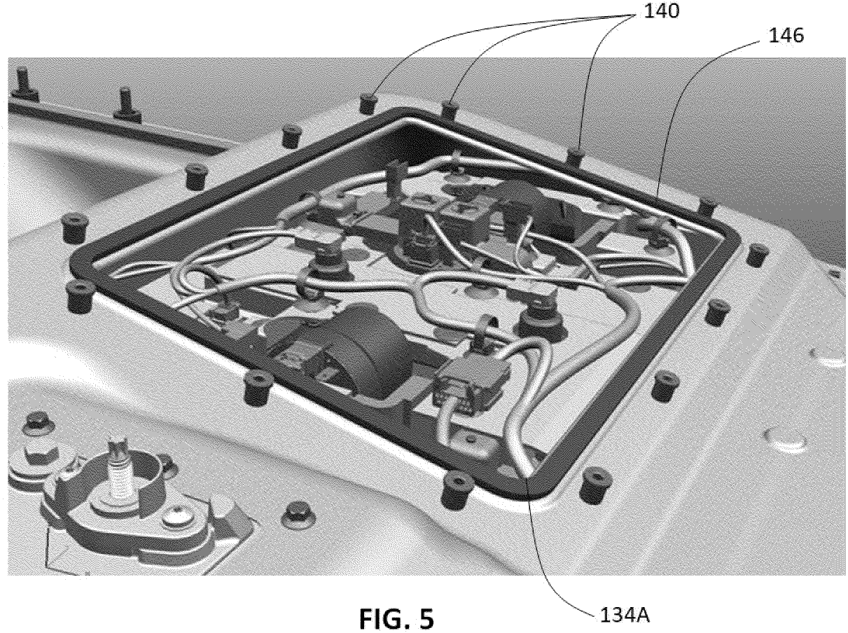

With additional reference to FIG. 5, access to the battery compartment 114 can be gained without a need to remove the entire battery pack 100 from the vehicle 108. For example, in some embodiments, the one or more access doors 134A/B can be accessed by removal of the rear seat 138, thereby exposing the service lids 102A/B. Thereafter, the service lids 102A/B, which can be secured to the cover 106 via a plurality of fasteners 140 and adhesive 146, can be removed thereby providing selective access to the battery compartment 114.

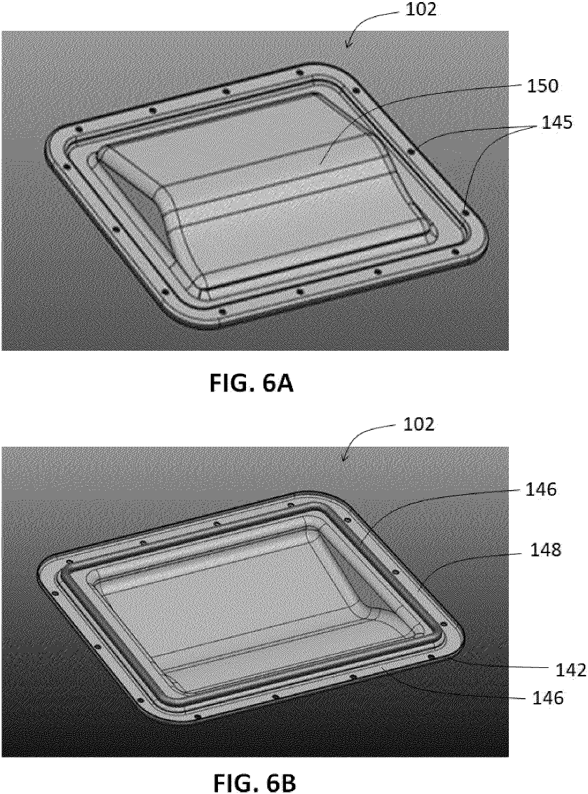

With additional reference to FIG. 6A/B, respective top and bottom perspective views of an example service lid 102 are depicted in accordance with an embodiment of the disclosure. In some embodiments, each service lid 102 can have a substantially rectangular perimeter 142, which in some embodiments can include filleted or rounded corners. In some embodiments, the service lid 102 can define a channel 144, for example having a generally U-shaped cross-section, in proximity to the perimeter 142. In addition to providing structural support to the service lid 102, the channel 144 can provide a proper spacing for the fasteners 140 for operable coupling to the cover 106. In embodiments, a plurality of apertures 145 configured to receive respective fasteners 140, can be defined along the channel 144.

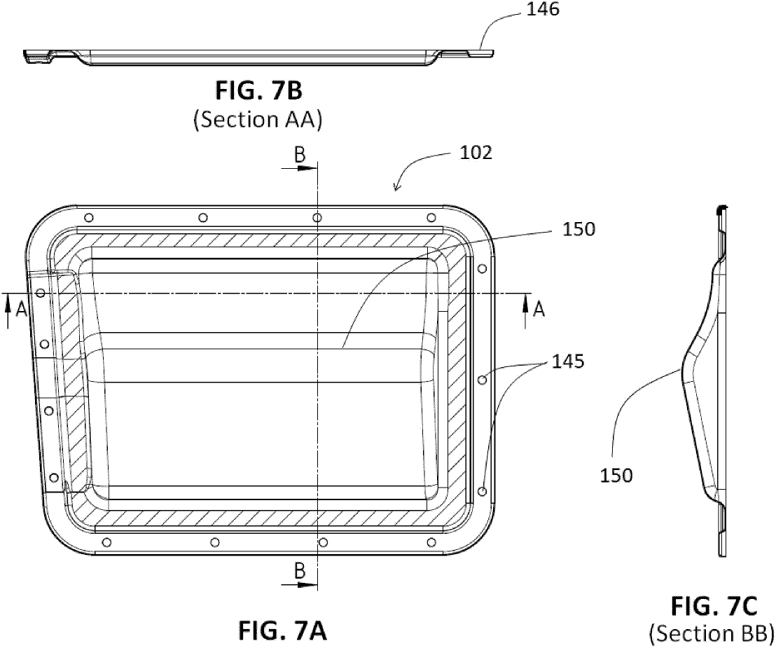

With additional reference to FIGS. 7A-C, a top plan view and respective cross-sectional views of the service lid 102 are provided in accordance with an embodiment of the disclosure. In some embodiments, a central portion 150 of the service lid 102 can be shaped to accommodate components of the battery pack 100 partially protruding out of the battery compartment 114 through the access door 134. For example, in some embodiments, a portion of the battery management system 130/current management system 132 can protrude slightly outwardly, with the service lid 102 shaped and sized to provide sufficient clearance, while ensuring a proper seal of the access door 134 to the cover 106. Construction of the service lid 102 to accommodate a variety of shapes can be performed according to a number of different methods, for example, in one embodiment, the service lid 102 can be stamped from a stock of sheet metal; although other methods of construction are also contemplated.

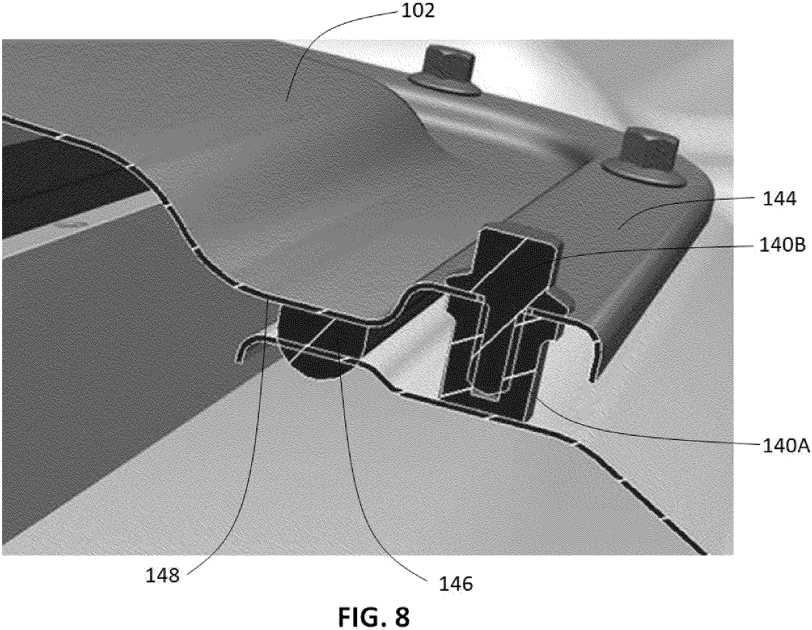

With additional reference to FIG. 8, in some embodiments, a gasket or adhesive 146 can be positioned inboard of the channel 144 on a bottom surface 148 of the service lid 102, thereby providing a fluid tight seal between the service lid 102 and the cover 106. For example, in one embodiment, the battery pack 100 can be sealed with an adhesive gasket 146, with the channel 144 and fasteners 140 arranged to maintain a small gap or clearance for proper compression of the gasket 146, thereby enabling repeated access to the battery compartment 114 for servicing. In some embodiments, the service lid 102 can be configured to enable In some embodiments, the fasteners 140A/B, which can be in the form of a two-part bolt/nut combination, can be tightened to a specific torque requirement (e.g., 13 Nm, etc.) to ensure proper compression of the gasket 146 against the cover 106.

The invention is further illustrated by the following embodiments:

A vehicle battery pack for an electric vehicle, comprising: a battery tray defining a battery compartment configured to house at least one of plurality of battery modules or individual battery cells; a cover configured to operably coupled to the battery tray, thereby sealing the battery compartment, the cover defining two or more access doors; and two or more service lids operably coupleable to the cover, thereby selectively providing access to the battery compartment through the two or more access doors.

A system or method according to any embodiment, wherein removal of the two or more access doors enables a user to at least one of perform diagnostics, change a fuse, reset a replay, or perform software updates to the battery pack.

A system or method according to any embodiment, wherein each of the service lids are substantially rectangular in shape.

A system or method according to any embodiment, wherein the two or more access doors are positioned on an aft portion of the cover.

A system or method according to any embodiment, wherein the cover defines a foot well for a backseat of the electric vehicle.

A system or method according to any embodiment, wherein the two or more access doors are positioned aft of the foot well.

A system or method according to any embodiment, wherein the two or more access doors are positioned on a portion of the cover positioned beneath a back seat of the electric vehicle.

A system or method according to any embodiment, wherein the two or more service lids are secured to the cover via a plurality of fasteners.

A system or method according to any embodiment, further comprising an adhesive gasket positioned between each service lid and the cover, the adhesive gasket providing a seal between each service lid and the cover.

A system or method according to any embodiment, wherein each of the service lids define a U-shaped channel arranged around a perimeter of the service lid.

A system or method according to any embodiment, wherein the U-shaped channel defines a plurality of apertures are configured to receive a corresponding plurality of fasteners.

A system or method according to any embodiment, wherein each of the service lids is constructed through a process of stamping sheet metal.

A system or method according to any embodiment, wherein a central portion of each service lid is shaped to accommodate one or more components of the battery pack partially protruding through the two or more access doors.

A system or method according to any embodiment, wherein the battery tray is further configured to house at least one of a current management system, current transmission system, a temperature regulation system, a safety system, and a battery management system.

An electric vehicle comprising the battery pack according to any embodiment.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A vehicle battery pack for electric vehicle, the vehicle battery pack comprising:
a battery tray defining a battery compartment configured to house at least one of plurality of battery modules or individual battery cells, a current transmission system, a temperature regulation system, a safety system, a battery management system, and a current management system;
a cover configured to operably coupled to the battery tray, thereby sealing the battery compartment, the cover defining two or more access doors; and
two or more service lids operably coupleable to the cover, thereby selectively providing access to the battery compartment through the two or more access doors.

2. The vehicle battery pack of claim 1, wherein the two or more access doors are positioned on an aft portion of the cover.

3. The vehicle battery pack of claim 1, wherein the cover defines a foot well for a backseat of the electric vehicle.

4. The vehicle battery pack of claim 3, wherein the two or more access doors are positioned aft of the foot well.

5. The vehicle battery pack of claim 1, wherein the two or more service lids are accessible by removal of the backseat.

6. The vehicle battery pack of claim 1, wherein the two or more service lids are secured to the cover via a plurality of fasteners.

7. The vehicle battery pack of claim 1, further comprising an adhesive gasket positioned between each service lid and the cover, the adhesive gasket providing a seal between each service lid and the cover.

8. A selectively sealable vehicle battery pack for electric vehicle configured to enable selective access to components within the battery pack, without a need to remove the battery pack from a vehicle in which it is installed, the battery pack comprising:
a vessel defining a compartment configured to house at least one of plurality of battery modules or individual battery cells, a current transmission system, a temperature regulation system, a safety system, a battery management system, and a current management system;
a cover configured to operably coupled to the vessel, thereby sealing the compartment, the cover defining two or more access doors; and
two or more service lids operably coupleable to the cover, thereby selectively providing access to the battery compartment through the two or more access doors.

9. The battery pack of claim 8, wherein the two or more access doors are positioned on a portion of the cover positioned beneath a back seat of the electric vehicle.

10. The battery pack of claim 8, wherein the cover defines a foot well for a backseat of the electric vehicle.

11. The battery pack of claim 8, wherein each of the service lids are substantially rectangular in shape.

12. The battery pack of claim 8, wherein each of the service lids define a U-shaped channel arranged around a perimeter of the service lid.

13. The battery pack of claim 12, wherein the U-shaped channel defines a plurality of apertures are configured to receive a corresponding plurality of fasteners.

14. The battery pack of claim 8, wherein the two or more service lids are secured to the cover via a plurality of fasteners.

15. The battery pack of claim 8, wherein each of the service lids is constructed through a process of stamping sheet metal.

16. The battery pack of claim 8, further comprising an adhesive gasket positioned between each service lid and the cover, the adhesive gasket providing a seal between each service lid and the cover.

17. The battery pack of claim 8, wherein a central portion of each service lid is shaped to accommodate one or more components of the battery pack partially protruding through the two or more access doors.

18. The battery pack of claim 8, wherein at least one of a battery management system or a current management system positioned within the compartment is accessible by removal of the two or more access doors.

19. The battery pack of claim 8, wherein removal of the two or more access doors enables a user to at least one of perform diagnostics, change a fuse, reset a replay, or perform software updates to the battery pack.

20. A vehicle battery pack for electric vehicle, the vehicle battery pack comprising:
a battery tray defining a battery compartment configured to house at least one of plurality of battery modules or individual battery cells, a current transmission system, a temperature regulation system, a safety system, a battery management system, and a current management system;
a cover configured to operably coupled to the battery tray, thereby sealing the battery compartment, the cover defining a foot well for a backseat to the electric vehicle and two or more access doors, wherein the two or more access doors are positioned aft of the foot well; and
two or more substantially rectangular service lids operably coupleable to the cover, thereby selectively providing access to the battery compartment through the two or more access doors, wherein each of the service lids define a U-shaped channel arranged around a perimeter of the service lid, the channel defining a plurality of apertures configured to receive a corresponding plurality of fasteners, wherein the two or more service lids are secured to the cover via the plurality of fasteners; and
an adhesive gasket positioned between each service lid and the cover, the adhesive gasket providing a seal between each service lid and the cover,
wherein the two or more service lids are accessible by removal of the backseat of the vehicle.
